(19) United States
(12) Patent Application Publication
(10) Pub. No.: US 2004/0196937 A1
(43) Pub. Date: Oct. 7, 2004

(54) Apparatus and method for clock adjustment in receiver of communication system

(75) Inventors: Wen-Chi Wang, Yunlin County (TW); Jui-Cheng Huang, Hsinchu (TW); Chin Chieh-Chuan, Taichung City (TW); Hsin-Min Wang, Kaohsiung City (TW)

Correspondence Address: BACON & THOMAS, PLLC, 625 SLATERS LANE, FOURTH FLOOR, ALEXANDRIA, VA, 22314

(73) Assignee: Realtek Semiconductor Corp., Hsinchu (TW)

(21) Appl. No.: 10/793,834

(22) Filed: Mar. 8, 2004

(30) Foreign Application Priority Data
Apr. 4, 2003 (TW) 092107801

(51) Int. Cl. H04L 25/00

(52) U.S. Cl. 375/355; 375/371

(57) ABSTRACT

An apparatus and method for clock adjustment in a receiving end of a communication system. The receiving end includes an analog to digital converter (ADC) and a frequency/phase error estimator. The ADC receives a transmitting signal and converts to a digital signal. The frequency/phase error estimator receives the digital signal and accordingly outputs a phase error signal. The device for clock adjustment includes a shaping filter and a phase adjuster. The shaping filter outputs a phase adjustment signal in accordance with the phase error signal and has a noise shaping property. The phase adjuster is connected to the shaping filter for outputting a clock signal in accordance with the phase adjustment signal.

### BACKGROUND OF THE INVENTION

1. Field of the Invention

The present invention relates to the technical field of clock synchronization and, more particularly, to an apparatus and method for clock adjustment.

2. Description of Related Art

FIG. 1 shows a conventional communication system. As shown, the system includes a pair of transmitting-end and receiving-end devices, denoted by 100 and 110 respectively. In FIG. 1, the receiving-end device 110 is located on a user side to receive downstream data sent by the transmitting-end device 100 or to send upstream data to the transmitting-end device. When receiving/transmitting data, the transmitting-end device 100 and the receiving-end device 110 have the same sampling frequency. However, the frequency may drift away from designated range due to factors such as noises or system characteristics.

FIG. 2 is a block diagram of a conventional receiving-end device 110. As shown in FIG. 2, the device 110 uses an analog-to-digital converter (ADC) 200 to receive signals coming in through a cable, a frequency/phase error estimator 210 to acquire frequency/phase error information between the devices 100 and 110. According to the frequency/phase error information, a reference clock generator 220 generates an adjustment signal, which is then utilized in adjusting a reference clock generator 220 for generating an adjusted clock. The adjusted clock can then be provided to the ADC for sampling, or to other circuits of the receiving-end device 110 for various uses. The frequency/phase error estimator 210 can be an analog circuit or a digital-signal-processing device for estimating frequency/phase error.

FIG. 3 shows a block diagram of another typical receiving-end device. As shown in FIG. 3, the device uses an ADC 300 to receive signals through a cable, and uses a frequency/phase error estimator 310 to estimate frequency/phase error between the transmitting-end device 100 and the receiving-end device 110. Based on the frequency/phase error, an adjustment signal is generated to adjust a frequency/phase adjuster 320. Next, the frequency/phase adjuster 320 generates a selection signal to select an appropriate clock signal from a plurality of clock signals with different phases of a phase swallower 330. The clock signal selected is provided to the ADC 300 for sampling. When the phase of the receiving-end clock lags behind the phase of the transmitting-end clock, the frequency/phase error estimator 310 generates an adjustment signal to the frequency/phase adjuster 320 for selecting a clock signal with shorter period in the phase swallower 330. Conversely, when the phase of the receiving-end clock leads ahead of the phase of the transmitting-end clock, the frequency/phase error estimator 310 generates an adjustment signal to the frequency/phase adjuster 320 for selecting a clock signal with longer period in the phase swallower 330. As such, the clock phase is compensated.

However, there are certain disadvantages in the aforementioned skill. Namely, when adjusting phase, the adjustment signal is updated after a period of time (such as about 512 bit time). This means that such phase compensation techniques tend to create jitter in the ADC 300. In addition, as shown in FIG. 4, which shows a power spectrum density of noise generated by a typical clock adjuster. The power spectrum density of the noise generated by the typical clock adjuster is uniformly distributed over all frequency. That is, at all frequencies, including the signal band, the noise has the same intensity.

### SUMMARY OF THE INVENTION

One of the many objects of the present invention is to provide an apparatus and method for clock adjustment in a receiving end of a communication system.

According to an embodiment of the present invention, an apparatus for adjusting a phase of a clock signal in a receiver is disclosed. The receiver includes a phase error estimator for generating a phase error signal according to a received signal. The apparatus comprises a shaping filter, coupled to the phase error estimator, for producing a phase adjustment signal according to the phase error signal, wherein the shaping filter has a noise shaping characteristic; a phase adjuster, coupled to the shaping filter, for adjusting the phase of the clock signal based on the phase adjustment signal.

According to another embodiment of the present invention, a method for adjusting a phase of a clock signal is disclosed. The method comprises the steps of generating an estimated phase error signal according to a received signal; modulating the estimated phase error signal with a noise shaping characteristic to produce a phase adjustment signal; and adjusting the phase of the clock signal according to the phase adjustment signal.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a conventional communication system;

FIG. 2 is a block diagram of a conventional receiving-end device;

FIG. 3 is a block diagram of another conventional receiving-end device;

FIG. 4 is a power spectrum density of noise generated by a typical clock adjuster;

FIG. 5 is a block diagram of a clock adjustment device in a receiving end of a communication system according to an embodiment of the invention;

FIG. 6 is a circuit of a clock adjustment device in a receiving end of a communication system according to an embodiment of the invention;

FIG. 7 is a schematic diagram of signals transmitted between transmitting and receiving ends according to an embodiment of the invention;

FIG. 8 is a time sequence diagram of clock phase error of transmitting end and receiving end; and

FIG. 9 is power spectrum density of noise generated by the clock adjuster according to an embodiment of the invention.

### DETAILED DESCRIPTION OF THE PREFERRED EMBODIMENT

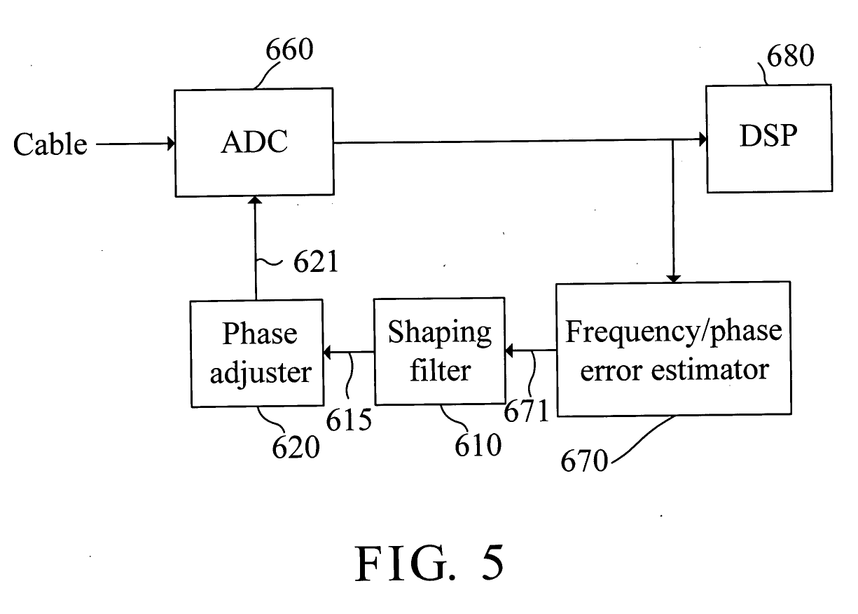

FIG. 5 is a block diagram of a device for clock adjustment in a receiving end of a communication system according to an embodiment of the invention. In FIG. 5, the receiving end includes an analog-to-digital converter (ADC) 660, a frequency/phase error estimator 670, a shaping filter 610 and a phase adjuster 620. The ADC 660 receives a transmitting signal outputted by a transmitting side and converts the transmitting signal into a digital signal. The digital signal represents the phase of the transmitting signal. The frequency/phase error estimator 670 receives the digital signal, accordingly estimates phase error for the received signal and then outputs a phase error signal 671. The shaping filter 610 is coupled to the phase error signal 671 and accordingly outputs a phase adjustment signal 615. The phase adjustment signal 615 has three output states of up, hold and down. The shaping filter 610 has a noise shaping property and can be, without limitation, a Delta-Sigma modulator. That is, the phase adjustment signal 615 is generated according to the modulation result of the Delta-Sigma modulator on the phase error signal 671. The phase adjuster 620 is connected to the shaping filter 610 and outputs a clock signal 621 in accordance with the phase adjustment signal 615. The clock signal 621 is output to the ADC 660 for use in sampling.

The phase adjustment signal 615 can be of values +1, 0, −1 for representing up, hold, down, respectively. When the phase adjustment signal 615 is up, the phase adjuster 620 outputs the clock signal 621 with one phase delay as compared to an original clock signal. When the phase adjustment signal 615 is hold, the phase adjuster 620 outputs the clock signal 621 with the same phase as the original clock signal. When the phase adjustment signal 615 is down, the phase adjuster 620 outputs the clock signal 621 with one phase advance as compared to the original clock signal.

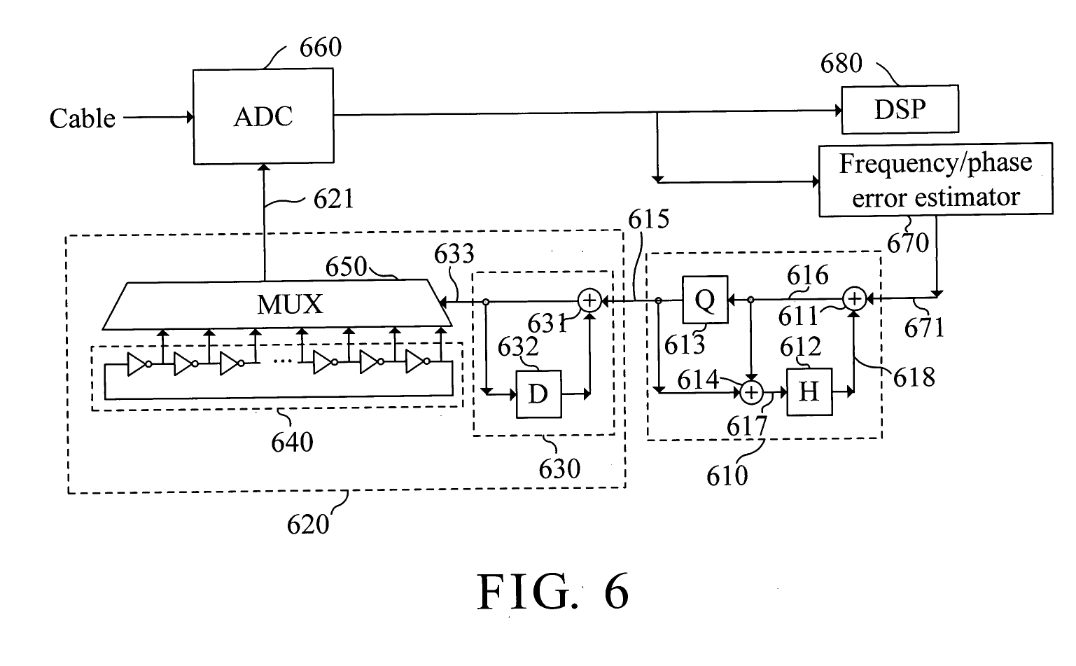

FIG. 6 is a schematic diagram of a circuit of FIG. 5. In FIG. 6, the shaping filter 610 has a first adder 611, a second adder 614, a quantizer 613, and an error feedback device 612. The adder 611 has a first input terminal to receive the phase error signal 671 generated by the frequency/phase error estimator 670, a second input terminal connected to an output terminal of the error feedback device 612, and an output terminal connected to both an input terminal of the quantizer 613 and a first input terminal of the second adder 614 in order to output a first addition signal 616. The quantizer 613 has an output terminal connected to both an input terminal of the phase adjuster 620 and a second input terminal of the second adder 614. The quantizer 613 quantizes the first addition signal 616 to generate the phase adjustment signal 615. The second adder 614 having an output terminal connected to an input terminal of the error feedback device 612 receives the first addition signal 616 and the phase adjustment signal 615 and accordingly outputs a second addition signal 617. The error feedback device 612 filters the second addition signal 617 to generate a feedback filtered signal 618.

The phase adjuster 620 includes a multi-phase generator 640, control logic 630 and a phase selector 650. The multi-phase generator 640 generates a plurality of phase signals with different phases. The control logic 630 receives the phase adjustment signal 615 and generates a phase selection signal 633. The phase selector 650 is coupled to the control logic 630 and the multi-phase generator 640 in order to select the clock signal 621 out of the phase signals according to the phase selection signal 633. The clock signal 621 is output to the ADC 660 as a sampling clock for sampling the input signal. One embodiment of the control logic 630 is a ring counter. The ring counter 630 includes a third adder 631 and a register 632. The third adder 631 has a first input terminal connected to an output terminal of the quantizer 613, a second input terminal connected to an output terminal of the register 632 and an output terminal connected to input terminals of the phase selector 650 and the register 632.

In this embodiment, the shaping filter 610 is embodied with Delta-Sigma modulation function to cancel clock jitter caused by the phase error signal 671 generated by the frequency/phase error estimator 670. FIG. 7 shows a schematic diagram of signals transmitted between transmitting and receiving ends in accordance with the invention. As shown in FIG. 7, before sending a transmitting-end digital signal S(nT) to the receiving end, the digital signal S(nT) is converted by a DAC 810 into an analog signal S(t). Next, the analog signal S(t) is sent to the receiving end through a cable. Then, the analog signal S(t) is converted by the ADC 660 into a digital signal S(nT+Δtₙ). It is assumed that a sampling frequency (1/T) is much higher than the signal pulse width, and the digital signal S(nT+Δtₙ) can be represented as:

$$S ( nT + Δ {t}_{n} ) ≅ S ( nT ) + {S}^{•} ( nT ) Δ {t}_{n} ≅ S ( nT ) + \frac{S ( nT ) - S ( ( n - 1 ) T )}{T} Δ {t}_{n} . \qquad ( 1 )$$

Therefore, noise caused by phase difference between sampling frequencies of the transmitting end and the receiving end can be represented as:

$$noise = S ( nT + Δ {t}_{n} ) - S ( nT ) = \frac{S ( nT ) - S ( ( n - 1 ) T )}{T} Δ {t}_{n} . \qquad ( 2 )$$

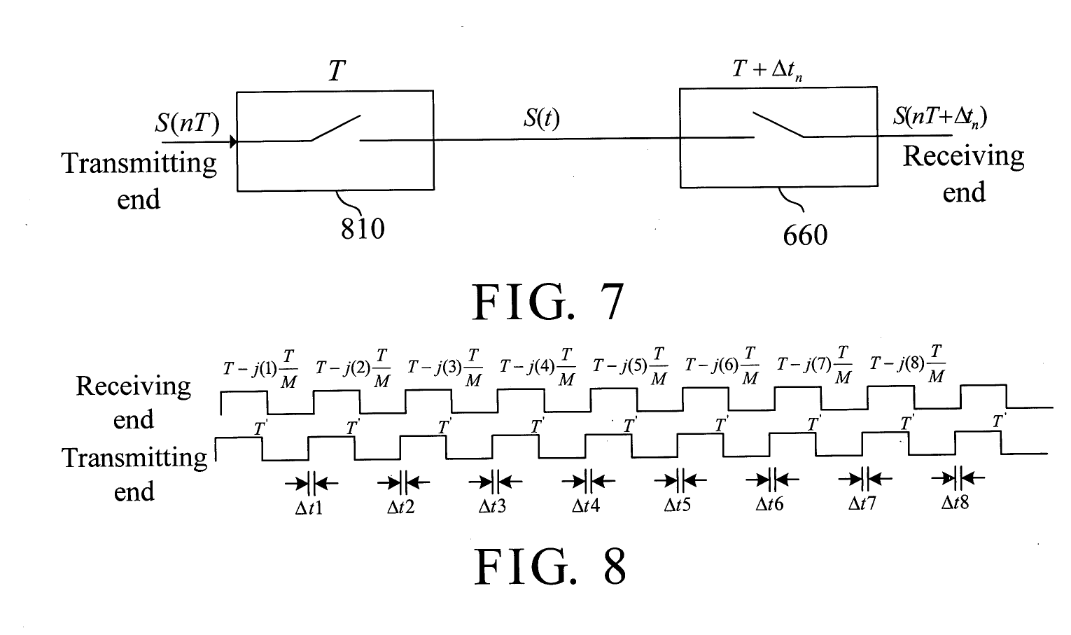

By referring to the relationship between the clocks of the receiving end and the transmitting end in FIG. 8, Δtₙ, can be then represented as:

$$Δ {t}_{n} = {\sum }_{i = 1}^{n} \{ [ T - j ( i ) \frac{T}{M} ] - {T}^{′} \} , \qquad ( 3 )$$

wherein M represents a number of phase segments that a clock is divided into. Accordingly, equation (3) can be rewritten as:

$$\begin{matrix}Δ {t}_{n} = {\sum }_{i = 1}^{n} \{ [ T - j ( i ) \frac{T}{M} ] - {T}^{′} \} \\ = {\sum }_{i = 1}^{n} \{ [ ( T - {T}^{′} ) - j ( i ) \frac{T}{M} ] \} \\ ≅ {\sum }_{i = 1}^{n} \{ ( ppm ) T - j ( i ) \frac{T}{M} \} \\ = {\sum }_{i = 1}^{n} ( ppm - \frac{j ( i )}{M} ) T ,\end{matrix} \qquad ( 4 )$$

wherein ppm represents a phase difference between sampling frequencies of the transmitting end and the receiving end. After Z-transform is applied to the noise in equation (2) and the equation (4) is substituted into the equation (2), an equation (5) is obtained as:

$$Z ( noise ) = [ S ( z ) \frac{1 - {z}^{- 1}}{T} ] ⊗ Z [ Δ {t}_{n} ] = [ S ( z ) \frac{1 - {z}^{- 1}}{T} ] ⊗ [ \frac{Z ( ppm ) - \frac{J ( z )}{M}}{1 - {z}^{- 1}} \times T ] . \qquad ( 5 )$$

Since the shaping filter 610 with Delta-Sigma modulation function is used, an equation (6) is obtained as:

J(z)=Z(DC)+(1−z⁻¹)ⁿQ=M×Z(ppm)+(1−z⁻¹)ⁿQ, (6)

wherein DC is the input signal of the shaping filter. Further, equation (6) is substituted into the equation (5), and an equation (7) is obtained as:

$$Z ( noise ) = [ S ( z ) \frac{1 - {z}^{- 1}}{T} ] ⊗ [ {( 1 - {z}^{- 1} )}^{N} \frac{QT}{M} ] . \qquad ( 7 )$$

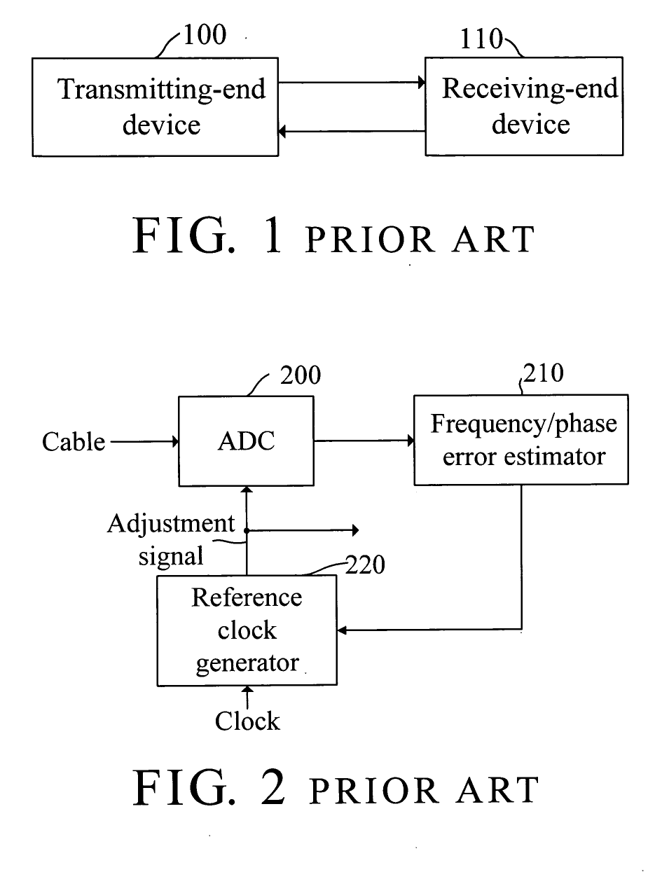

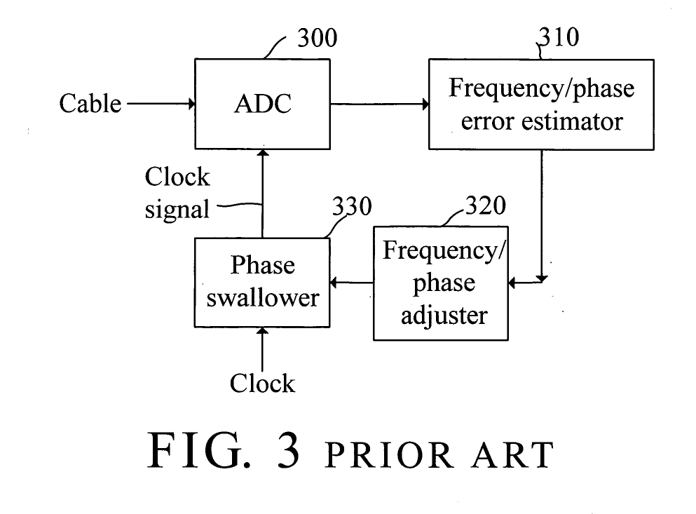

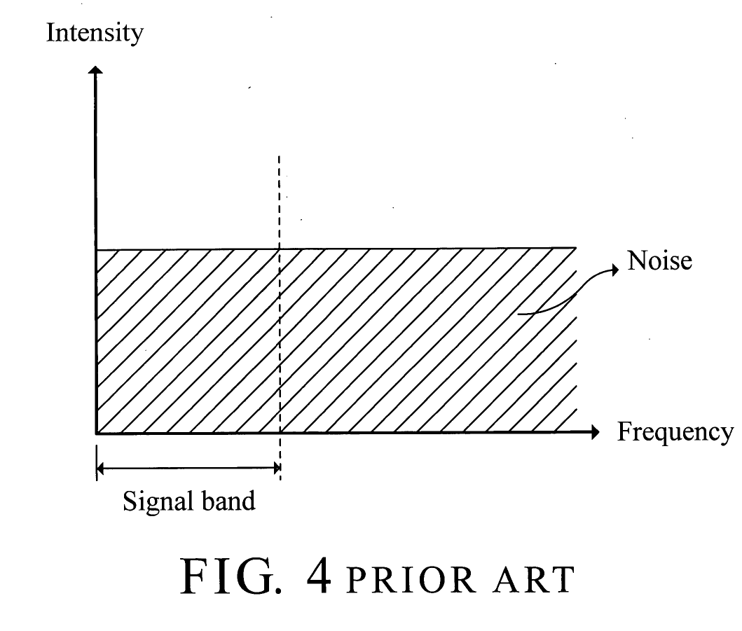

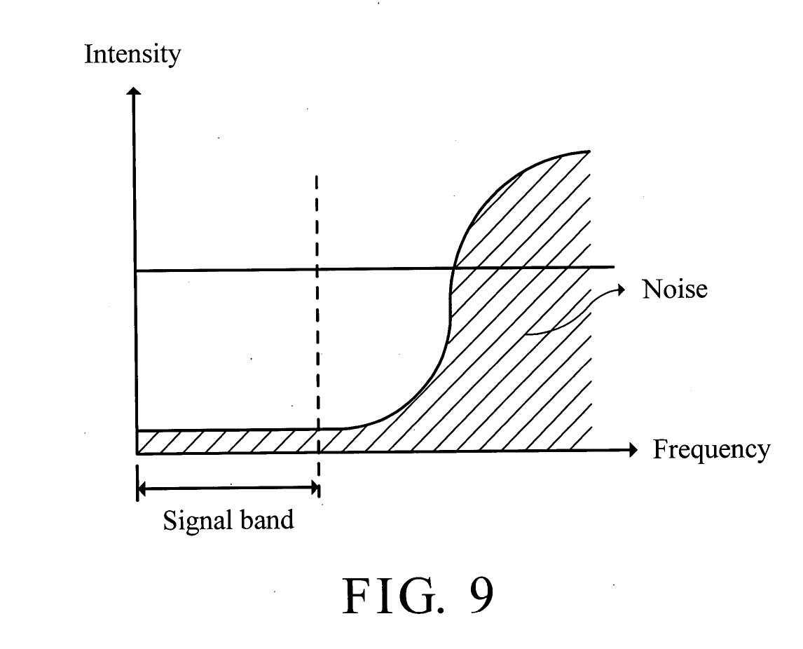

As seen in equation (7), the ppm term is eliminated. That is, noise is not affected by the ppm term, i.e., noise is not affected by phase difference between sampling frequencies of the transmitting end and the receiving end. As shown in FIG. 9, the shaping filter 610 with Delta-Sigma modulation function can change uniform distribution of the noise by shifting most of the power spectrum density of pattern noise to higher frequency area. Comparing FIG. 2 and FIG. 9, the apparatus and method for clock adjustment according to embodiments of the invention can use the noise-shaping feature of the shaping filter 610 to shift power spectrum density of pattern noise to higher frequency area and thus reduces intensity of noise in the signal band. Accordingly, noise that affects signal is dramatically reduced and signal to noise ratio (SNR) is increased.

Although the present invention has been explained in relation to the described embodiments, it is to be understood that many other possible modifications and variations can be made without departing from the spirit and scope of the invention as hereinafter claimed.

What is claimed is:

1. An apparatus for adjusting a phase of a clock signal in a receiver, the receiver including a phase error estimator for generating a phase error signal in accordance with a received signal, the apparatus comprising:
a shaping filter, coupled to the phase error estimator, for producing a phase adjustment signal in accordance with the phase error signal, wherein the shaping filter has a noise shaping characteristic;
a phase adjuster, coupled to the shaping filter, for adjusting the phase of the clock signal based on the phase adjustment signal.

2. The apparatus of claim 1, wherein the phase adjustment signal is a tri-state signal, which can be of a first value, a second value, or a third value.

3. The apparatus of claim 2, wherein the first value indicates that the phase adjuster outputs the clock signal with one phase delay as compared with an original clock signal.

4. The apparatus of claim 2, wherein the second value indicates that the phase adjuster outputs the clock signal with the same phase as an original clock signal.

5. The apparatus of claim 2, wherein the second value indicates that the phase adjuster outputs the clock signal with one phase advance as compared with an original clock signal.

6. The apparatus of claim 1, wherein the phase adjuster comprises:
a multi-phase generator for generating a plurality of clock signals with different phases;
a control logic for generating a phase selection signal in accordance with the phase adjustment signal; and
a phase selector for selecting one of the clock signals as the clock signal in accordance with the phase selection signal.

7. The apparatus of claim 6, wherein the control logic is a ring counter.

8. The apparatus of claim 1, wherein the shaping filter is a Delta-Sigma filter.

9. The apparatus of claim 1, wherein the shaping filter includes:
a first adder for outputting a first addition signal according to the phase error signal and a feedback filter signal;
a quantizer for outputting the phase adjustment signal by quantizing the first addition signal;
a second adder for outputting a second addition signal according to the first addition signal and the phase adjustment signal; and
a feedback filter for generating the feedback filter signal by filtering the second addition signal.

10. A method for adjusting a phase of a clock signal, comprising the steps of:
generating an estimated phase error signal according to a received signal;
modulating the estimated phase error signal with a noise shaping characteristic to produce a phase adjustment signal; and
adjusting the phase of the clock signal according to the phase adjustment signal.

11. The method of claim 10, wherein the adjusting step comprises:
generating a plurality of phase signals, wherein the phase signals have different phases; and
selectively outputting one of the phase signals in accordance with the phase adjustment signal.

12. The method of claim 10, wherein the phase adjustment signal is a tri-state signal, which can be of a first value, a second value, and a third value.

13. The method of claim 12, wherein in the adjusting step when the phase adjustment signal is the first value, the one phase signal selected has one phase delay as compared to an original phase signal.

14. The method of claim 12, wherein in the adjusting step when the phase adjustment signal is the second value, the one phase signal selected has the same phase as an original phase signal.

15. The method of claim 12, wherein in the adjusting step when the phase adjustment signal is the third value, the one phase signal selected has one phase advance as compared to an original phase signal.

16. The method of claim 10, wherein the step of generating a phase adjustment signal is performed by using Delta-Sigma modulation.
